(19) United States
(12) Patent Application Publication
(10) Pub. No.: US 2023/0103431 A1
(43) Pub. Date: Apr. 6, 2023

(54) VORTEX RING GENERATION DEVICE

(71) Applicant: DAIKIN INDUSTRIES, LTD., Osaka (JP)

(72) Inventors: Chie EMURA, Osaka (JP); Tomoyuki HAIKAWA, Osaka (JP); Yousuke IMAI, Osaka (JP); Masafumi UDA, Osaka (JP); Mizuho UENO, Osaka (JP); Takayuki KIKUCHI, Osaka (JP); Chiho FUJII, Osaka (JP); Michiko KAIHOTSU, Osaka (JP)

(21) Appl. No.: 18/078,859

(22) Filed: Dec. 9, 2022

Related U.S. Application Data
(63) Continuation of application No. PCT/JP2021/022163, filed on Jun. 10, 2021.

(30) Foreign Application Priority Data
Jun. 10, 2020 (JP) 2020-100870

(51) Int. Cl. F15D 1/00

(52) U.S. Cl. CPC F15D 1/009

(57) ABSTRACT

A vortex ring generation device is configured to release an airflow in a form of a vortex ring from a release port. The vortex ring generation device includes a plurality of gas chamber units, an actuator, and a communication path. Each gas chamber unit has an air chamber that communicates with the release port. Each gas chamber units includes a fixing member forming the air chamber, and a movable member moving to push air out of the air chamber. The movable members of all of the gas chamber units are coupled together to form one movable body. The actuator is connected to an end portion of the movable body and is configured to drive the movable body. The communication path allows the air chambers of the plurality of gas chamber units to communicate with each other.

### CROSS-REFERENCE TO RELATED APPLICATIONS

This is a continuation of International Application No. PCT/JP2021/022163 filed on Jun. 10, 2021, which claims priority to Japanese Patent Application No. 2020-100870, filed on Jun. 10, 2020. The entire disclosures of these applications are incorporated by reference herein.

### BACKGROUND

### Technical Field

The present disclosure relates to a vortex ring generation device.

### Background Art

A vortex ring generation device that has been disclosed generates air in the form of vortex rings (hereinafter simply referred to as “vortex rings”) from a release port. A vortex ring generation device of Japanese Unexamined Patent Publication No. 2020-51729 includes a casing having a release port, and a pushing mechanism. The pushing mechanism includes one diaphragm, and moves this diaphragm to push air out. In this vortex ring generation device, the air pushed out by the pushing mechanism forms a vortex ring, and is released from the release port.

### SUMMARY

A first aspect of the present disclosure is directed to a vortex ring generation device for releasing an airflow in a form of a vortex ring from a release port. The vortex ring generation device includes a plurality of gas chamber units, an actuator, and a communication path. Each gas chamber unit has an air chamber that communicates with the release port. Each gas chamber units includes a fixing member forming the air chamber, and a movable member moving to push air out of the air chamber. The movable members of all of the gas chamber units are coupled together to form one movable body. The actuator is connected to an end portion of the movable body and is configured to drive the movable body. The communication path allows the air chambers of the plurality of gas chamber units to communicate with each other.

### BRIEF DESCRIPTION OF THE DRAWINGS

FIG. 1 is a schematic cross-sectional view illustrating an internal structure of a vortex ring generation device according to a first embodiment.

FIG. 2 is an enlarged view illustrating a sealing portion and the vicinity of the sealing portion.

FIG. 3 is an explanatory drawing illustrating how air pushed out by movable members flows.

FIG. 4 is a cross-sectional view illustrating a vortex ring generation device according to a second embodiment and corresponding to FIG. 1.

FIG. 5 is a schematic cross-sectional view illustrating an internal structure of a vortex ring generation device according to a third embodiment.

FIG. 6 illustrates the appearance of a vortex ring generation device according to a fourth embodiment.

FIG. 7 is a perspective view of a longitudinal sectional view illustrating the vortex ring generation device according to the fourth embodiment.

FIG. 8 is a cross-sectional view taken along line VIII-VIII shown in FIG. 6.

FIG. 9 is a cross-sectional view taken along line IX-IX shown in FIG. 8.

FIG. 10 is a cross-sectional view taken along line X-X shown in FIG. 9.

FIG. 11 is an enlarged view of a joint between an actuator and a shaft portion and an area surrounding the joint.

FIG. 12 illustrates how air pushed out by movable members flows, and corresponds to FIG. 8.

### DETAILED DESCRIPTION OF EMBODIMENT(S)

### First Embodiment

A first embodiment will be described below. A vortex ring generation device (10) of this embodiment is a device for forming an airflow in the form of a vortex ring (a vortex ring (R)).

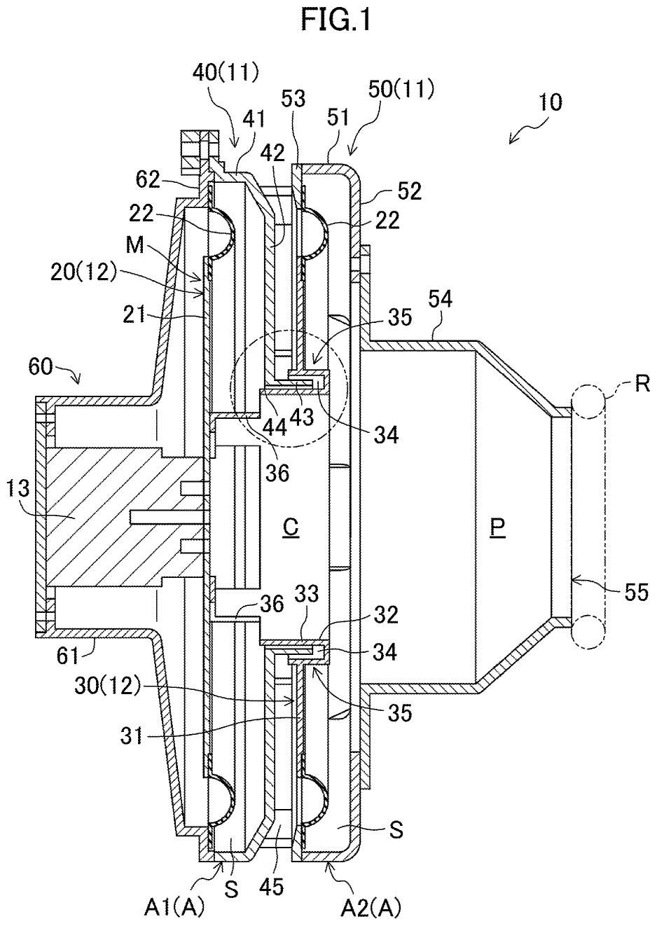

As illustrated in FIG. 1, the vortex ring generation device (10) includes a plurality of gas chamber units (A) and one actuator (13). In this embodiment, the number of the gas chamber units (A, A) of the vortex ring generation device (10) is two. An air chamber (S) is formed in each of the gas chamber units (A). One of the gas chamber units (A) has a release port (55).

In the vortex ring generation device (10), air pushed out of the air chambers (S) by a motion of the actuator (13) forms a vortex ring (R), which is released from the release port (55). The terms “right,” “left,” “front,” and “rear” in the following description refer to the directions when the release port (55) of the vortex ring generation device (10) is viewed from the front.

### Gas Chamber Unit

The two gas chamber units (A, A) of this embodiment are categorized as one first gas chamber unit (A1) and one second gas chamber unit (A2). The first gas chamber unit (A1) is disposed in front of the actuator (13). The second gas chamber unit (A2) is disposed in front of the first gas chamber unit (A1). The second gas chamber unit (A2) is adjacent to the first gas chamber unit (A1). In other words, the actuator (13), the first gas chamber unit (A1), and the second gas chamber unit (A2) are arranged in a straight line in this order from the rear forward.

Each gas chamber unit (A) includes a fixing member (11) and a movable member (12). A space surrounded by the fixing member (11) and the movable member (12) in each gas chamber unit (A) forms the air chamber (S). The fixing member (11) is in the shape of a circular dish. The movable member (12) is disposed to block a rear open surface of the fixing member (11). The movable member (12) moves relative to the fixing member (11). The movable member (12) moves to push air out of the air chamber (S).

The movable members (12) of all of the gas chamber units (A) are coupled together to form one movable body (M). In this embodiment, the movable body (M) includes the two movable members (12, 12). The movable body (M) is driven by the actuator (13). The two movable members (12, 12) are categorized as a direct-acting movable member (20) and a driven movable member (30).

The direct-acting movable member (20) is one of the two movable members (12) that form the movable body (M). In the vortex ring generation device (10) of this embodiment, the movable member (12) of the first gas chamber unit (A1) is the direct-acting movable member (20). The direct-acting movable member (20) is directly coupled to the actuator (13).

The driven movable member (30) is one of the movable members (12) that form the movable body (M) except the direct-acting movable member (20). In the vortex ring generation device (10) of this embodiment, the movable member (12) of the second gas chamber unit (A2) is the driven movable member (30). The driven movable member (30) is driven via the direct-acting movable member (20) by the actuator (13). Detailed structures of the direct-acting movable member (20) and the driven movable member (30) will be described below.

The first gas chamber unit (A1) includes a first fixing member (40), an actuator support (60), and the direct-acting movable member (20). The second gas chamber unit (A2) includes a second fixing member (50) and the driven movable member (30).

### First Fixing Member

The first fixing member (40) is in the shape of a circular dish, and is installed such that its opening surface faces rearward. The first fixing member (40) includes a first body portion (41), a first front panel portion (42), a protruding portion (43), and connectors (45).

The first body portion (41) is in the shape of a short cylinder or a ring. The first front panel portion (42) is a plate-shaped portion in the shape of a flat ring, and is disposed to block the front open surface of the first body portion (41). The first front panel portion (42) extends radially inward from the front edge of the first body portion (41). The first front panel portion (42) has a communication opening (44) at its center. The communication opening (44) is circular. The axis of the communication opening (44) generally coincides with the axis of the first body portion (41). The communication opening (44) allows the air chamber (S) of the first gas chamber unit (A1) to communicate with a tubular portion (33) of the driven movable member (30) to be described later.

The protruding portion (43) is tubular. The protruding portion (43) extends forward from the communication opening (44) of the first front panel portion (42). The connectors (45) extend forward from a peripheral portion of the first front panel portion (42). The connectors (45) couple together the first front panel portion (42) and a second rear panel portion (53) of the second fixing member (50) to be described later. The number of the connectors (45) is eight, and the eight connectors (45) are equally spaced apart from one another in the circumferential direction of the first front panel portion (42).

### Actuator Support

The actuator support (60) is disposed behind the first fixing member (40), and is fixed to the first fixing member (40). The actuator support (60) includes a frame portion (61) and a connecting panel portion (62).

The frame portion (61) is a portion for supporting the actuator (13). The frame portion (61) is in the shape of a circular dish, and is installed such that its opening surface faces forward. The frame portion (61) extends forward from its rear end surface, and has a reverse tapered shape that has its diameter increased forward from an intermediate portion thereof. The axis of the frame portion (61) generally coincides with the axis of the first body portion (41) of the first fixing member (40). The actuator (13) is disposed in the center of the frame portion (61). The frame portion (61) surrounds the actuator (13).

The connecting panel portion (62) is a plate-shaped portion in the shape of a flat ring, and extends radially outward from the front outer edge of the frame portion (61). The connecting panel portion (62) is fixed to the rear edge of the first body portion (41) of the first fixing member (40).

### Second Fixing Member

The second fixing member (50) is in the shape of a circular dish, and is installed such that its opening surface faces rearward. The second fixing member (50) includes a second body portion (51), a second front panel portion (52), a second rear panel portion (53), and a nozzle member (54).

The second body portion (51) is in the shape of a short cylinder or a ring. The second front panel portion (52) is a plate-shaped portion in the shape of a flat ring, and is disposed to block the front open surface of the second body portion (51). The second front panel portion (52) extends radially inward from the front edge of the second body portion (51).

The second rear panel portion (53) is a plate-shaped portion in the shape of a flat ring, and is disposed to block the rear open surface of the second body portion (51). The second rear panel portion (53) extends radially inward from the rear edge of the second body portion (51). The inside diameter of the second rear panel portion (53) is generally equal to the inside diameter of the connecting panel portion (62) of the actuator support (60).

The nozzle member (54) is a cylindrical member. The nozzle member (54) is attached to a central portion of the second front panel portion (52). The axis of the nozzle member (54) generally coincides with the axis of the second body portion (51). The nozzle member (54) extends forward from the second front panel portion (52), and has a tapered shape that has its diameter reduced from an intermediate portion thereof toward the front. The inside diameter of a rear end portion of the nozzle member (54) is smaller than the inside diameter of the second rear panel portion (53). The inside diameter of a front end portion of the nozzle member (54) is smaller than the inside diameter of the rear end portion. An opening of the nozzle member (54) located at the front end thereof is the release port (55).

The release port (55) is formed only in the second fixing member (50). The release port (55) is a circular opening. The diameter of the release port (55) is smaller than the inside diameter of the second front panel portion (52). In this embodiment, the second front panel portion (52) and the nozzle member (54) are separate from each other, but may be integrated together.

### Direct-Acting Movable Member

In the vortex ring generation device (10) of this embodiment, the movable member (12) of the first gas chamber unit (A1) is the direct-acting movable member (20).

The direct-acting movable member (20) includes a direct-acting flat panel portion (21) and an elastic support (22). The direct-acting flat panel portion (21) corresponds to a flat panel portion of the present disclosure. The direct-acting flat panel portion (21) is a circular plate-shaped member. The direct-acting flat panel portion (21) faces the air chamber (S) of the first gas chamber unit (A1). The axis of the direct-acting flat panel portion (21) is positioned to generally coincide with the axis of the first body portion (41).

The elastic support (22) of the direct-acting movable member (20) is a frame-shaped member made of an elastic material, such as rubber. The elastic support (22) of the direct-acting movable member (20) is provided on an entire outer edge portion of the direct-acting flat panel portion (21). An outer edge portion of the elastic support (22) of the direct-acting movable member (20) is fixed to an inner edge portion of the connecting panel portion (62) of the actuator support (60). The direct-acting flat panel portion (21) and the elastic support (22) are disposed to block the open surface of the first fixing member (40) facing rearward. In other words, the direct-acting flat panel portion (21) is coupled to the first fixing member (40) via the elastic support (22).

The actuator (13) is connected to a central portion of the rear surface of the direct-acting movable member (20). A motion of the actuator (13) causes the direct-acting movable member (20) to vibrate in the forward and rearward directions.

### Driven Movable Member

In the vortex ring generation device (10) of this embodiment, the movable member (12) of the second gas chamber unit (A2) is the driven movable member (30).

The driven movable member (30) includes a driven flat panel portion (31), an elastic support (22), a tubular portion (33), and coupling portions (36). The driven flat panel portion (31) corresponds to a flat panel portion of the present disclosure. The driven flat panel portion (31) is a plate-shaped member in the shape of a ring. The driven flat panel portion (31) faces the air chamber (S) of the second gas chamber unit (A2).

The axis of the driven flat panel portion (31) generally coincides with the axis of the direct-acting flat panel portion (21). In other words, the driven flat panel portion (31) and the direct-acting flat panel portion (21) are coaxial with each other. The driven flat panel portion (31) is generally parallel to the direct-acting flat panel portion (21). The driven flat panel portion (31) and the direct-acting flat panel portion (21) are arranged in the front-to-rear direction. The outside diameter of the driven flat panel portion (31) is generally equal to the outside diameter of the direct-acting flat panel portion (21). The driven flat panel portion (31) is closer to the front than the first fixing member (40) is.

The elastic support (22) of the driven movable member (30) is similar to the elastic support (22) of the direct-acting movable member (20). The elastic support (22) of the driven movable member (30) is provided on an entire outer edge portion of the driven flat panel portion (31). The driven flat panel portion (31) and the elastic support (22) are disposed to block the open surface of the second fixing member (50) facing rearward. In other words, the driven flat panel portion (31) is coupled to the second fixing member (50) via the associated elastic support (22).

The driven flat panel portion (31) has a through hole (32) at its center. In other words, the through hole (32) is formed in the driven movable member (30). The through hole (32) is circular. The axis of the through hole (32) generally coincides with the axis of the driven flat panel portion (31). The through hole (32) of the driven flat panel portion (31) is provided with the tubular portion (33). In other words, the tubular portion (33) passes through the flat panel portions (31).

The tubular portion (33) is cylindrical. The axis of the tubular portion (33) generally coincides with the axis of the driven flat panel portion (31). The tubular portion (33) extends rearward from the driven flat panel portion (31). The tubular portion (33) is positioned so as to be fitted into the protruding portion (43) of the first fixing member (40). One end portion (a front end portion) of the tubular portion (33) is closer to the front than the driven flat panel portion (31) is. The other end portion (a rear end portion) of the tubular portion (33) is closer to the rear than the communication opening (44) of the first fixing member (40) is.

The one end portion (front end portion) of the tubular portion (33) opens to the air chamber (S) of the second gas chamber unit (A2). The other end portion (rear end portion) of the tubular portion (33) opens to the air chamber (S) of the first gas chamber unit (A1). The tubular portion (33) allows the air chamber (S) of the second gas chamber unit (A2) to communicate with the air chamber (S) of the first gas chamber unit (A1). The inside diameter of the tubular portion (33) is larger than the diameter of the release port (55).

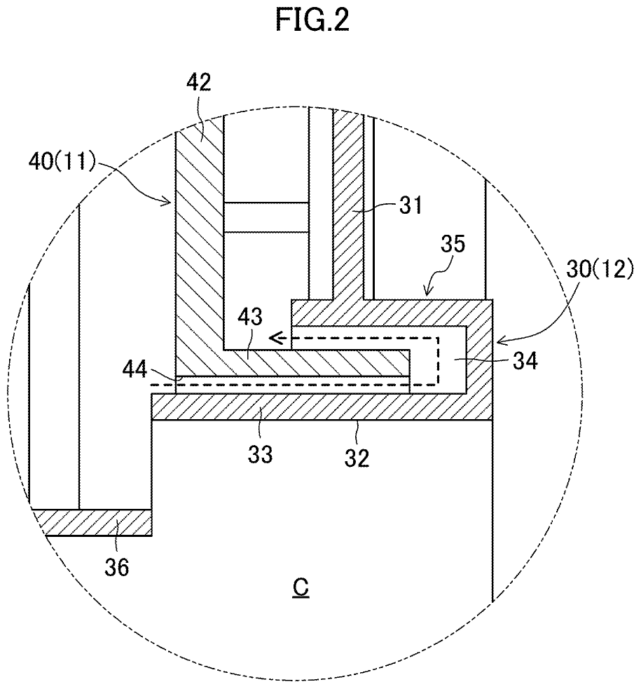

As illustrated in FIG. 2, a seal recess portion (34) is formed between the tubular portion (33) and the driven flat panel portion (31). The seal recess portion (34) is in the shape of a ring. The seal recess portion (34) extends toward the first fixing member (40). The axis of the seal recess portion (34) generally coincides with the axis of the tubular portion (33). The protruding portion (43) of the first fixing member (40) is fitted into the seal recess portion (34). The seal recess portion (34) and the protruding portion (43) are not in contact with each other. Thus, the driven movable member (30) can move in the forward and rearward directions without being restricted by the first fixing member (40).

In this embodiment, the seal recess portion (34) of the driven movable member (30) and the protruding portion (43) of the first fixing member (40) form a sealing portion (35). The sealing portion (35) is a kind of labyrinth seal formed by the protruding portion (43) of the first fixing member (40) entering the seal recess portion (34) of the driven movable member (30). The sealing portion (35) reduces the leakage of air from the gap between the tubular portion (33) of the driven movable member (30) and the first fixing member (40).

As indicated by the dashed arrow in FIG. 2, a portion of air pushed out of the air chamber (S) of the first gas chamber unit (A1) flows into a narrow clearance formed between the inner peripheral surface of the protruding portion (43) and the outer peripheral surface of the tubular portion (33). The air that has entered this narrow clearance turns back along a protruding end portion of the protruding portion (43), and then further flows through a narrow clearance along the outer peripheral surface of the protruding portion (43). As can be seen, the air that has flowed into the clearance formed between the inner peripheral surface of the protruding portion (43) and the outer peripheral surface of the tubular portion (33) flows through the very narrow clearance over a relatively long distance. This reduces the flow rate of the air leaking through the clearance to a very low rate.

The coupling portions (36) are in the shape of a circular arc-shaped panel, and extend rearward from the other end portion (rear end portion) of the tubular portion (33). In this embodiment, the number of the coupling portions (36) is four. The coupling portions (36) are equally spaced apart from one another in the circumferential direction of the tubular portion (33). The space between each adjacent pair of the coupling portions (36) is open to the air chamber (S) of the first gas chamber unit (A1).

The rear end portion of each coupling portion (36) is bent radially inward. The outer surface of the bent portion of each coupling portion (36) is joined to the direct-acting flat panel portion (21). In other words, the coupling portions (36) couple the tubular portion (33) of the driven movable member (30) to the direct-acting movable member (20) of the first gas chamber unit (A1). As can be seen, the direct-acting movable member (20) and the driven movable member (30) are coupled together via the coupling portions (36) to form the one movable body (M).

### Air Chamber, Communication Path, Air Passage

In the first gas chamber unit (A1), a space surrounded by the first body portion (41) and the first front panel portion (42) of the first fixing member (40), and the direct-acting flat panel portion (21) and the elastic support (22) of the direct-acting movable member (20) serves as one of the air chambers (S).

In the second gas chamber unit (A2), a space surrounded by the second body portion (51) and the second front panel portion (52) of the second fixing member (50), and the driven flat panel portion (31) and the elastic support (22) of the driven movable member (30) serves as the other one of the air chambers (S).

The vortex ring generation device (10) has a communication path (C). The communication path (C) allows the air chambers (S) of the plurality of gas chamber units (A) to communicate with each other. In this embodiment, the air chamber (S) of the first gas chamber unit (A1) and the air chamber (S) of the second gas chamber unit (A2) communicate with each other through the tubular portion (33) of the driven movable member (30). The tubular portion (33) forms the communication path (C). In other words, the communication path (C) allows the air chamber (S) of the first gas chamber unit (A1) to communicate with the air chamber (S) of the second gas chamber unit (A2). The communication path (C) passes through the driven flat panel portion (31) of the driven movable member (30).

The nozzle member (54) has therein the air passage (P) from the rear end portion thereof to the release port (55) at the front end portion thereof. The air chamber (S) of the first gas chamber unit (A1) communicates with the release port (55) via the tubular portion (33), the air chamber (S) of the second gas chamber unit (A2), and the air passage (P). The air chamber (S) of the second gas chamber unit (A2) communicates with the release port (55) via the air passage (P). In other words, the air chamber (S) of each gas chamber unit (A) communicates with the release port (55).

### Actuator

The actuator (13) is connected to the rear end of the movable body (M). The actuator (13) of this embodiment is disposed behind the direct-acting movable member (20) in the first gas chamber unit (A1). The actuator (13) is connected to the direct-acting flat panel portion (21) of the direct-acting movable member (20). The actuator (13) is in the shape of a cylindrical column. Although not shown, the actuator (13) includes a magnet and a coil, and drives the movable body (M) by electromagnetic force. The axis of a body portion (13) generally coincides with the axis of the direct-acting flat panel portion (21).

The actuator (13) linearly reciprocates the movable body (M) in the forward and rearward directions. In other words, the actuator (13) reciprocates the movable body (M) along the direction of arrangement of the plurality of movable members (12) (in the forward and rearward directions). Specifically, the actuator (13) drives the movable body (M) such that all of the movable members (12) that form the movable body (M) move simultaneously in the direction in which air is pushed out of the air chambers (S) corresponding to the movable members (12). The actuator (13) vibrates the movable body (M) between the reference position and the pushed position. This allows air in the air chamber (S) of each gas chamber unit (A) to be pushed out forward.

### Operation

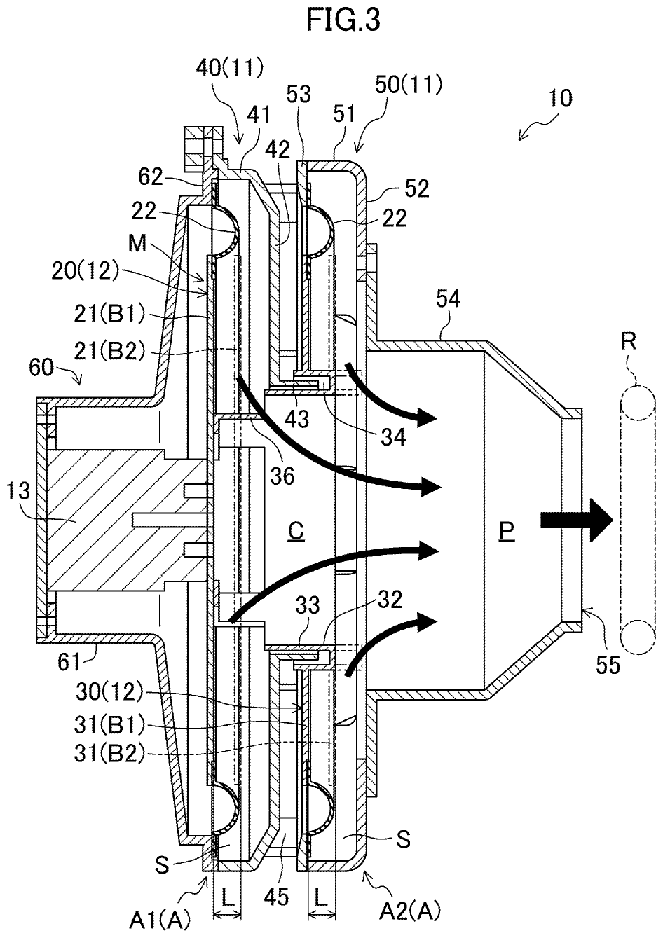

Basic operation of the vortex ring generation device (10) will be described with reference to FIG. 3.

While the vortex ring generation device (10) is in an operating state, the actuator (13) reciprocates the movable body (M) forward and rearward. Specifically, driving of the actuator (13) causes driving of the direct-acting movable member (20) directly coupled to the actuator (13). The driving of the direct-acting movable member (20) causes the driven movable member (30) coupled to the direct-acting movable member (20) to be driven in an integrated manner.

If the driving of the actuator (13) causes the direct-acting flat panel portion (21) of the direct-acting movable member (20) to move forward (to the position indicated as “B2” in FIG. 3), the capacity of the air chamber (S) of the first gas chamber unit (A1) decreases. The decrease in the capacity of the air chamber (S) of the first gas chamber unit (A1) causes air with a volume equal to the capacity decrement to be pushed out of the air chamber (S). The air pushed out of the air chamber (S) flows into the air passage (P) through the communication path (C) formed in the tubular portion (33) of the driven movable member (30) and the air chamber (S) of the second gas chamber unit (A2).

The direct-acting movable member (20) moving forward causes the driven flat panel portion (31) of the driven movable member (30) to also move forward (to the position indicated as “B2” in FIG. 3). Thus, the capacity of the air chamber (S) of the second gas chamber unit (A2) decreases. The decrease in the capacity of the air chamber (S) of the second gas chamber unit (A2) causes air with a volume equal to the capacity decrement to be pushed out of the air chamber (S). The air pushed out of the air chamber (S) flows into the air passage (P), and joins the air that has flowed from the air chamber (S) of the first gas chamber unit (A1) into the air passage (P). The joined air flows through the air passage (P) toward the release port (55).

While the air is released from the release port (55) at a relatively high flow velocity, the air around the release port (55) is stationary. For this reason, a shearing force acts on the air at the plane of discontinuity of such two types of air flows to generate a vortex flow near the circumferential edge of the release port (55). This vortex flow forms air in the form of a vortex ring travelling forward from the release port (55) (the vortex ring indicated by the dashed and double-dotted lines in each of FIGS. 1 and 3).

The actuator (13) performs a reciprocating motion once every predetermined time. Specifically, in the vortex ring generation device (10) of this embodiment, when the predetermined time has elapsed since one vortex ring (R) is generated, a subsequent vortex ring (R) is generated. In this embodiment, the predetermined time ranges from 5 seconds to 10 seconds. When the predetermined time has elapsed since the actuator (13) vibrates a plurality of times in a reciprocating fashion, the actuator (13) may again vibrate a plurality of times in a reciprocating fashion. For example, a motion in which when the predetermined time has elapsed since three vortex rings (R) are successively generated at intervals of 0.3 seconds, three subsequent vortex rings (R) are generated may be repeated.

### Movement of Movable Member

While the vortex ring generation device (10) is in operation, the movable body (M) reciprocates between the reference position and the pushed position. While the actuator (13) is at rest, the movable body (M) is located at the reference position. While the movable body (M) is located at the reference position (the position indicated as “B1” in FIG. 3), the displacement of each of the direct-acting movable member (20) and the driven movable member (30) is zero. On the other hand, when the movable body (M) reaches the pushed position (the position indicated as “B2” in FIG. 3), the direct-acting movable member (20) and the driven movable member (30) move forward. In other words, the direct-acting movable member (20) and the driven movable member (30) bulge forward.

The distance from the reference position to the pushed position is the stroke L of the actuator (13). Here, when the movable body (M) moves once from the reference position to the pushed position, the volume V1 of the air pushed out of the air chamber (S) of the first gas chamber unit (A1) is a value obtained by multiplying the front surface area S1 of the direct-acting flat panel portion (21) by the stroke L (V1=S1×L). The volume V2 of the air pushed out of the air chamber (S) of the second gas chamber unit (A2) is a value obtained by multiplying the front surface area S2 of the driven flat panel portion (31) by the stroke L (V2=S2×L). The volume V of the air released from the vortex ring generation device (10) every time the movable body (M) moves is the sum of the volumes V1 and V2 (V=V1+V2).

As can be seen, coupling the plurality of gas chamber units (A) together allows the amount of the air released from the vortex ring generation device (10) to be larger than if the vortex ring generation device (10) includes one gas chamber unit. Arranging the plurality of gas chamber units (A) in a line along the direction of movement of the movable body (M) can substantially keep the size of the vortex ring generation device (10) from increasing radially outward.

### Feature (1) of First Embodiment

In the vortex ring generation device (10) of this embodiment, the movable members (12) of all of the gas chamber units (A) are coupled together to form the one movable body (M). The vortex ring generation device (10) includes the actuator (13) connected to an end of the movable body (M) and configured to drive the movable body (M), and the communication path (C) that allows the air chambers (S) of the plurality of gas chamber units (A) to communicate with each other.

In the vortex ring generation device (10) of this embodiment, the plurality of gas chamber units (A) each have the air chamber (S), and each include the movable member (12) pushing air out of the associated air chamber (S). This allows a larger amount of air to be released than if air is pushed out of an air chamber (S) of one gas chamber unit (A).

In the vortex ring generation device (10) of this embodiment, the movable members (12) of all of the gas chamber units (A) are coupled together to form the one movable body (M). The movable body (M) is driven by the actuator (13) connected to the end of the movable body (M). The air pushed out of the air chambers (S) of the gas chamber units (A) through the motion of the actuator (13) passes through the communication path (C), and is released from the release port (55) to the outside of the vortex ring generation device (10). This can increase the amount of the air released from the release port (55) without increasing the size of the movable member (12) of each gas chamber unit (A). As a result, the size of the vortex ring generation device (10) can substantially be kept from increasing.

### Feature (2) of First Embodiment

The plurality of gas chamber units (A) of this embodiment are arranged in a line.

### Feature (3) of First Embodiment

In the vortex ring generation device (10) of this embodiment, the actuator (13) reciprocates the movable body (M), and the plurality of gas chamber units (A) are arranged in a line along the direction of movement of the movable body (M).

Since the plurality of gas chamber units (A) are arranged in a line along the direction of movement of the movable body (M), the size of the vortex ring generation device (10) can substantially be kept from increasing in the direction perpendicular to the direction of movement of the movable body (M).

### Feature (4) of First Embodiment

In the vortex ring generation device (10) of this embodiment, the movable members (12) of all of the gas chamber units (A) are coupled together to form the one movable body (M). The vortex ring generation device (10) includes the actuator (13) configured to drive the movable body (M), and the communication path (C) that allows the air chamber (S) of the first gas chamber unit (A1) to communicate with the air chamber (S) of the second gas chamber unit (A2).

The air chamber (S) of the first gas chamber unit (A1) communicates with the air chamber (S) of the second gas chamber unit (A2) via the communication path (C). The air pushed out of the air chamber (S) of the first gas chamber unit (A1) flows through the communication path (C) into the air chamber (S) of the second gas chamber unit (A2), and is released from the release port (55) formed in the second gas chamber unit (A2) to the outside of the vortex ring generation device (10) together with the air in the air chamber (S) of the second gas chamber unit (A2). This can shorten the communication path (C), resulting in a reduction in the channel resistance of the communication path (C).

### Feature (5) of First Embodiment

In the vortex ring generation device (10) of this embodiment, one of the plurality of movable members (12) that form the movable body (M) is the direct-acting movable member (20) directly coupled to the actuator (13), and one of the movable members (12) that form the movable body (M) except the direct-acting movable member (20) is the driven movable member (30) driven by the actuator (13) via the direct-acting movable member (20).

Since the driven movable member (30) is driven by the actuator (13) via the direct-acting movable member (20), the actuator (13) can drive the plurality of movable members (12).

### Feature (6) of First Embodiment

The movable member (12) of each gas chamber unit (A) of this embodiment has the flat panel portion (21, 31) facing the associated air chamber (S).

Since each flat panel portion (21, 31) faces the associated air chamber (S), the movement of the flat panel portion (21, 31) causes air in the associated air chamber (S) to be pushed out.

### Feature (7) of First Embodiment

The flat panel portions (21, 31) of the movable members (12) of this embodiment are circular, and are coaxial with each other.

Since the flat panel portions (21, 31) are circular, a uniform air flow can be formed in the circumferential direction of the flat panel portions (21, 31). Further, since the flat panel portions (21, 31) are coaxial with each other, the air pushed out by the flat panel portions (21, 31) flows in the same direction.

### Feature (8) of First Embodiment

The actuator (13) of this embodiment reciprocates the movable body (M) along the direction of arrangement of the plurality of movable members (12) that form the movable body (M).

Since the actuator (13) reciprocates the movable body (M) along the direction of arrangement of the plurality of movable members (12), the air in the air chamber (S) of each gas chamber unit (A) is pushed out in the direction of arrangement of the plurality of movable members (12).

### Feature (9) of First Embodiment

The communication path (C) of this embodiment passes through the flat panel portion (21, 31) of at least one of the movable members (12).

Since the communication path (C) passes through the flat panel portion (21, 31) of the at least one of the movable members (12), a new member does not have to be used to form the communication path (C).

### Feature (10) of First Embodiment

One of the plurality of movable members (12) that form the movable body (M) of this embodiment is the direct-acting movable member (20) directly coupled to the actuator (13). One of the movable members (12) that form the movable body (M) of this embodiment except the direct-acting movable member (20) is the driven movable member (30) driven by the actuator (13) via the direct-acting movable member (20). The driven movable member (30) has the through hole (32) forming the communication path (C).

Since the driven movable member (30) is driven by the actuator (13) via the direct-acting movable member (20), the actuator (13) can drive the plurality of movable members (12). Since the driven movable member (30) has the through hole (32) forming the communication path (C), a new member does not have to be used to form the communication path (C).

### Feature (11) of First Embodiment

The through hole (32) of this embodiment is formed in the center of the flat panel portion (21, 31) of the driven movable member (30).

Since the through hole (32) is formed in the center of the flat panel portion (21, 31) of the driven movable member (30), the air pushed out by the other flat panel portion (21, 31) passes through the center of the flat panel portion (21, 31).

### Feature (12) of First Embodiment

The through hole (32) of this embodiment is circular.

Since the through hole (32) is circular, a uniform air flow can be formed in the circumferential direction of the through hole (32).

### Feature (13) of First Embodiment

At least one of the movable members (12) of this embodiment includes the flat panel portion (21, 31) facing the associated air chamber (S), and the tubular portion (33) passing through the flat panel portion (21, 31) to form the communication path (C).

The at least one movable member (12) includes the flat panel portion (21, 31) and the tubular portion (33). The movement of the flat panel portion (21, 31) causes the air in the air chamber (S) facing the flat panel portion (21, 31) to be pushed out. The tubular portion (33) passing through the flat panel portion (21, 31) forms at least one portion of the communication path (C).

### Feature (14) of First Embodiment

Each of the direct-acting movable member (20) and the driven movable member (30) of this embodiment includes the flat panel portion (21, 31) facing the associated air chamber (S). Out of the direct-acting movable member (20) and the driven movable member (30), only the driven movable member (30) further includes the tubular portion (33) passing through the flat panel portion (21, 31) to form the communication path (C).

Each of the direct-acting movable member (20) and the driven movable member (30) includes the flat panel portion (21, 31), which pushes the air out of the associated air chamber (S). The air pushed out by the flat panel portion (21) of the direct-acting movable member (20) passes through the tubular portion (33) of the driven movable member (30).

### Feature (15) of First Embodiment

The tubular portion (33) of the driven movable member (30) of this embodiment allows the air chamber (S) of one of the gas chamber units (A) including the driven movable member (30) to communicate with the air chamber (S) of another one of the gas chamber units (A) adjacent to the one of the gas chamber units (A) including the driven movable member (30).

The air pushed out of the air chamber (S) of the another one of the gas chamber units (A) adjacent to the one of the gas chamber units (A) including the driven movable member (30) having the tubular portion (33) passes through the tubular portion (33) to flow into the air chamber (S) of the one of the gas chamber units (A) including the driven movable member (30) having the tubular portion (33).

### Feature (16) of First Embodiment

The fixing member (11) of the another one of the gas chamber units (A) adjacent to the one of the gas chamber units (A) including the driven movable member (30) of this embodiment has the communication opening (44) that allows the air chamber (S) of the another one of the gas chamber units (A) to communicate with the tubular portion (33) of the movable member (12).

### Feature (17) of First Embodiment

Provided is the sealing portion (35) configured to seal the gap between the tubular portion (33) of the driven movable member (30) of this embodiment and the fixing member (11) of the another one of the gas chamber units (A) adjacent to the one of the gas chamber units (A) including the driven movable member (30).

Since the sealing portion (35) seals the gap between the tubular portion (33) of the driven movable member (30) and the fixing member (11) of the another one of the gas chamber units (A) adjacent to the one of the gas chamber units (A) including the driven movable member (30), the air can substantially be kept from leaking from the gap between the tubular portion (33) and the fixing member (11).

### Feature (18) of First Embodiment

The driven movable member (30) of this embodiment includes the coupling portion (36) configured to couple the tubular portion (33) of the driven movable member (30) to the direct-acting movable member (20) or the driven movable member (30) of the another one of the gas chamber units (A) adjacent to the one of the gas chamber units (A) including the driven movable member (30).

Since the driven movable member (30) includes the coupling portion (36), the driving force of the actuator (13) is transmitted from the direct-acting movable member (20) or the driven movable member (30) of the another one of the gas chamber units (A) adjacent to the one of the gas chamber units (A) including the driven movable member (30) having the tubular portion (33) to the driven movable member (30) having the tubular portion (33) via the coupling portion (36).

### Second Embodiment

A second embodiment will be described below. A vortex ring generation device (10) of this embodiment is a modified version, of the vortex ring generation device (10) of the first embodiment, in which the number of gas chamber units (A) have been changed. The following description of the vortex ring generation device (10) of this embodiment will be focused on the differences from the vortex ring generation device (10) of the first embodiment.

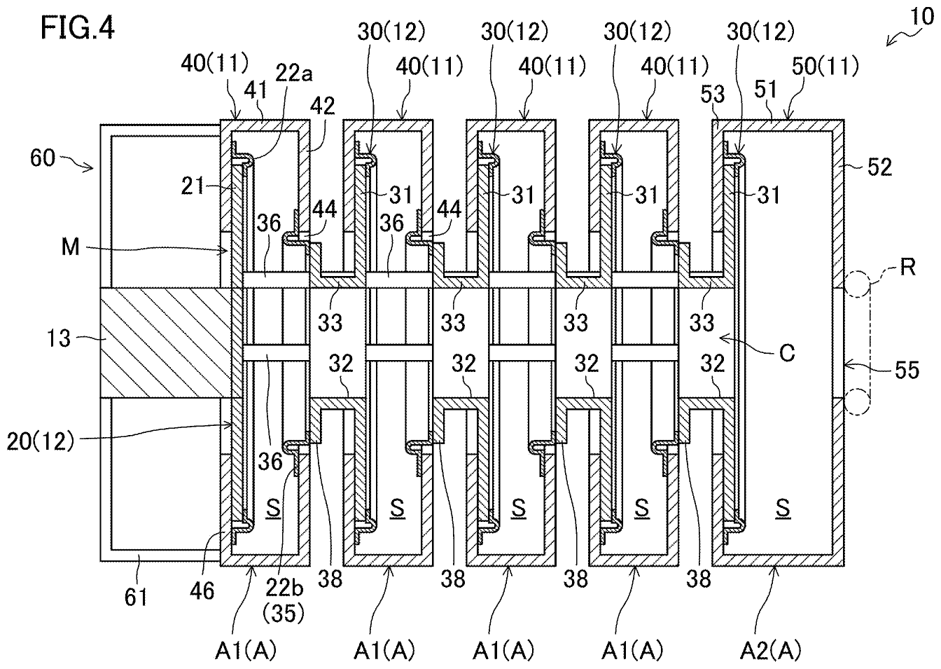

As illustrated in FIG. 4, the vortex ring generation device (10) of this embodiment includes five gas chamber units (A). The number of the gas chamber units (A) shown here is merely an example.

### Gas Chamber Unit

In the vortex ring generation device (10) of this embodiment, the five gas chamber units (A) are categorized as four first gas chamber units (A1) and one second gas chamber unit (A2). One of the first gas chamber units (A1) is disposed in front of an actuator (13). The first gas chamber units (A1) are arranged adjacent to one another in the front-to-rear direction. The second gas chamber unit (A2) is disposed in front of the foremost one of the first gas chamber units (A1). As with the first embodiment, each of the first gas chamber units (A1) includes a first fixing member (40), and the second gas chamber unit (A2) includes a second fixing member (50).

In the vortex ring generation device (10) of this embodiment, each gas chamber unit (A) includes one movable member (12), as with the first embodiment. The five movable members (12) are coupled together to form one movable body (M).

The five movable members (12) forming the movable body (M) are categorized as one direct-acting movable member (20) and four driven movable members (30). In the vortex ring generation device (10) of this embodiment, the movable member (12) of the rearmost one of the four first gas chamber units (A1) is the direct-acting movable member (20), and the movable members (12) of the remaining three first gas chamber units (A1) and the second gas chamber unit (A2) are the driven movable members (30).

The rearmost one of the first gas chamber units (A1) includes the first fixing member (40), an actuator support (60), and the direct-acting movable member (20). The remaining three first gas chamber units (A1) each include the first fixing member (40) and the driven movable member (30). The second gas chamber unit (A2) includes the second fixing member (50) and the driven movable member (30).

### First Fixing Member

The first fixing members (40) each include a first body portion (41), a first front panel portion (42), and a first rear panel portion (46). Unlike the first fixing members of the first embodiment, each of the first fixing members (40) of this embodiment further includes the first rear panel portion (46), and does not include a protruding portion and connectors. The first rear panel portion (46) corresponds to the connecting panel portion (62) of the actuator support (60) of the first embodiment. The first front panel portion (42) has a communication opening (44) at its center.

### Second Fixing Member

The second fixing member (50) includes a second body portion (51), a second front panel portion (52), and a second rear panel portion (53). Unlike the second fixing member of the first embodiment, the second fixing member (50) of this embodiment does not include a nozzle member. The second front panel portion (52) has a release port (55) at its center.

### Direct-Acting Movable Member, Driven Movable Member

The structure of the direct-acting movable member (20) is similar to that of the direct-acting movable member of the first embodiment. The driven movable members (30) each include a driven flat panel portion (31), a tubular portion (33), a blocking flat panel portion (38), a first elastic support (22a), a second elastic support (22b), and a coupling portion (36). The structures of the driven flat panel portion (31) and the tubular portion (33) are respectively similar to those of the first embodiment.

The blocking flat panel portion (38) is a plate-shaped portion that extends radially outward from the rear end of the tubular portion (33). The blocking flat panel portion (38) is in the shape of a flat ring. The blocking flat panel portion (38) is disposed to cover an open surface of the first front panel portion (42) of the gas chamber unit (A) located behind the gas chamber unit (A) including the blocking flat panel portion (38).

The first and second elastic supports (22a) and (22b) are similar to the elastic supports of the first embodiment, and are frame-shaped members made of an elastic material, such as rubber. The first elastic support (22a) is provided on an entire outer edge portion of the driven flat panel portion (31). The first elastic support (22a) couples together the driven flat panel portion (31) and the first rear panel portion (46) of the gas chamber unit (A) including the driven flat panel portion (31).

The second elastic support (22b) is provided on an entire outer edge portion of the blocking flat panel portion (38). The second elastic support (22b) couples together the blocking flat panel portion (38) and the first front panel portion (42) of the gas chamber unit (A) located behind the gas chamber unit (A) including the blocking flat panel portion (38). The second elastic support (22b) forms a sealing portion (35) configured to seal the gap between the driven movable member (30) including the second elastic support (22b) and the fixing member (11) of the gas chamber unit (A) located behind the gas chamber unit (A) including the second elastic support (22b).

The coupling portion (36) couples the tubular portion (33) of the driven movable member (30) to the direct-acting movable member (20) or the driven movable member (30) of one of the gas chamber units (A) located behind the gas chamber unit (A) including the driven movable member (30). The coupling portion (36) is a rod-shaped member that extends rearward from the rear surface of the associated driven flat panel portion (31). In this embodiment, the number of the coupling portions (36) is four.

### Communication Path

A communication path (C) of this embodiment is formed by the four tubular portions (33) arranged in a straight line. In other words, each of the four tubular portions (33) forms a portion of the communication path (C).

In the vortex ring generation device (10) of this embodiment, air chambers (S) of the first gas chamber units (A1) communicate with an air chamber (S) of the second gas chamber unit (A2) via the communication path (C). The actuator (13) moving the movable body (M) causes the air pushed out of the air chamber (S) of each first gas chamber unit (A1) to flow through the communication path (C) into the air chamber (S) of the second gas chamber unit (A2) and to be released through the release port (55) together with the air pushed out by the movable member (12) of the second gas chamber unit (A2). As a result, a vortex ring (R) is formed.

### Third Embodiment

A third embodiment will be described below. The following description of a vortex ring generation device (10) of this embodiment will be focused on the differences from the vortex ring generation device (10) of the second embodiment.

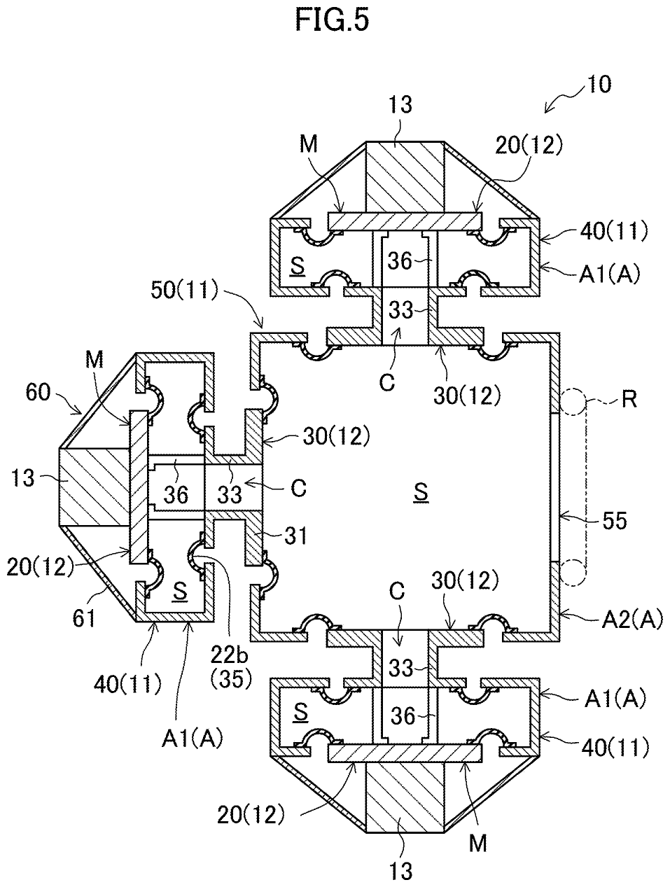

As illustrated in FIG. 5, the vortex ring generation device (10) of this embodiment includes four gas chamber units (A) and three actuators (13).

### Gas Chamber Unit

In the vortex ring generation device (10) of this embodiment, the four gas chamber units (A) are categorized as three first gas chamber units (A1) and one second gas chamber unit (A2). The first gas chamber units (A1) are arranged around the one second gas chamber unit (A2).

As with the second embodiment, each first gas chamber unit (A1) includes one fixing member (11) and one movable member (12). The fixing member (11) of each first gas chamber unit (A1) is a first fixing member (40). An actuator support (60) is disposed near a first rear panel portion (46) of each first fixing member (40). The actuator supports (60) are fixed to the associated first fixing members (40). The actuators (13) are attached to the associated first gas chamber units (A1). Each first gas chamber unit (A1) has its movable member (12) coupled to the actuator (13). The movable member (12) of each first gas chamber unit (A1) is a direct-acting movable member (20).

The second gas chamber unit (A2) includes one fixing member (11) and three movable members (12). The fixing member (11) of the second gas chamber unit (A2) is a second fixing member (50). The second fixing member (50) of this embodiment is in the shape of a hollow cube. The second fixing member (50) has a release port (55) that opens through one of its four side surfaces. The remaining three side surfaces are provided with the movable members (12), respectively. The three movable members (12) each correspond to one of the first gas chamber units (A1). Each movable member (12) is a driven movable member (30) coupled to the direct-acting movable member (20) of the corresponding first gas chamber unit (A1).

### Movable Body

Each of the direct-acting movable members (20) and one of the driven movable members (30) coupled together form one movable body (M). In the vortex ring generation device (10) of this embodiment, the number of the movable bodies (M) is three. Each movable body (M) is coupled to one of the actuators (13). Each actuator (13) reciprocates the associated one of the movable bodies (M).

### Communication Path

In the vortex ring generation device (10) of this embodiment, the three movable bodies (M) each form a communication path (C). Thus, the number of the communication paths (C) of the vortex ring generation device (10) of this embodiment is three. Each movable body (M) has its communication path (C) formed by a tubular portion (33) of the associated driven movable member (30). The communication path (C) formed by each movable body (M) allows an air chamber (S) of the first gas chamber unit (A1) including the movable body (M) to communicate with an air chamber (S) of the second gas chamber unit (A2).

Each actuator (13) moving one of the movable bodies (M) corresponding to the actuator (13) causes the air pushed out of the air chamber (S) of the associated first gas chamber unit (A1) to flow through the associated communication path (C) into the air chamber (S) of the second gas chamber unit (A2) and to be released through the release port (55) together with the air pushed out by the three driven movable members (30) of the second gas chamber unit (A2). As a result, a vortex ring (R) is formed.

### Fourth Embodiment

A fourth embodiment will be described below. A vortex ring generation device (10) of this embodiment is a modified version, of the vortex ring generation device (10) of the first embodiment, in which the configuration of the gas chamber units (A) and the location of the communication path (C) have been changed. The following description of the vortex ring generation device (10) of this embodiment will be focused on the differences from the vortex ring generation device (10) of the first embodiment.

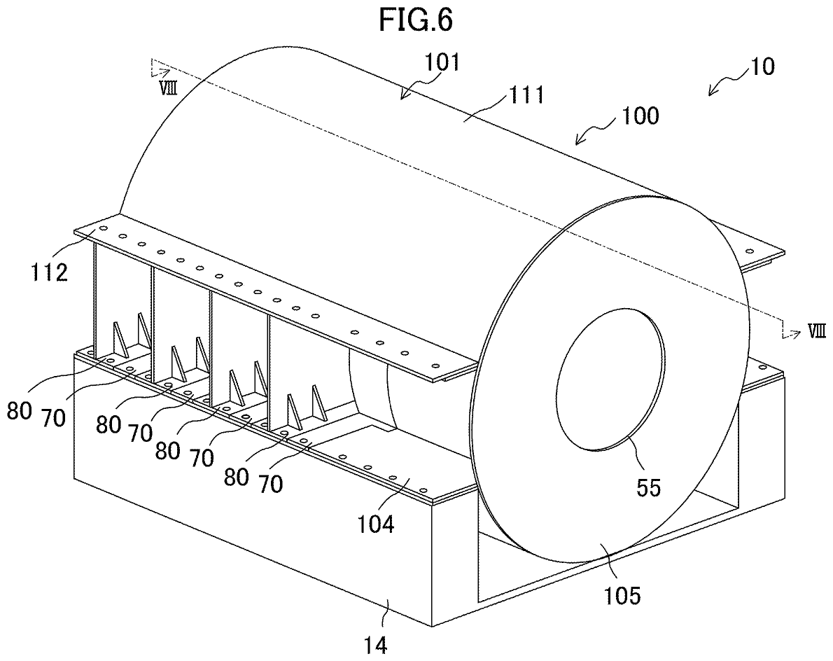

As illustrated in FIGS. 6 to 10, the vortex ring generation device (10) of this embodiment includes a plurality of gas chamber units (A), one actuator (13), and a passage forming member (100) forming a communication path (C). In this embodiment, the number of the gas chamber units (A) of the vortex ring generation device (10) is four. The number of the gas chamber units (A) shown here is merely an example.

### Gas Chamber Unit

The four gas chamber units (A) of this embodiment have the same structure. The gas chamber units (A) are linearly arranged in a line in the front-to-rear direction. Each gas chamber unit (A) includes a fixing member (11) and a movable member (12).

### Fixing Member

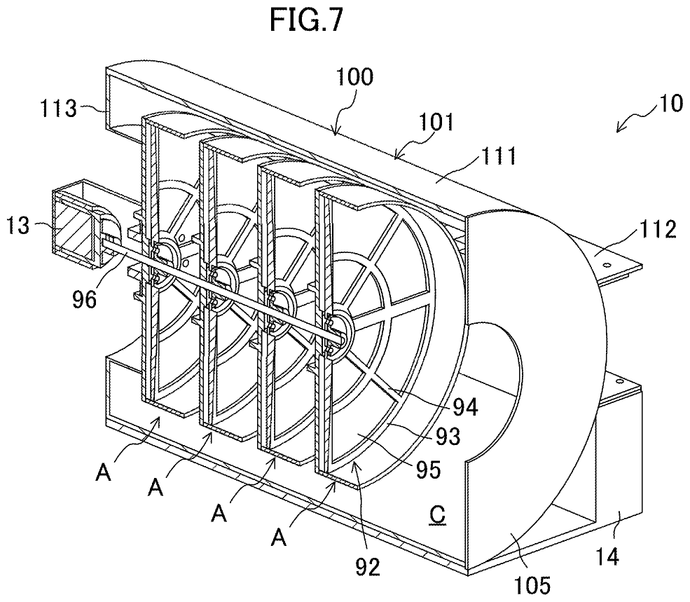

As illustrated in FIGS. 7 to 9, the fixing members (11) each include a tube portion (71) and a wall surface portion (81). The tube portions (71) each form part of a first member (70). The wall surface portions (81) each form part of a second member (80). Each of the first members (70) is disposed in front of the associated second member (80). In the vortex ring generation device (10) of this embodiment, the first members (70) and the second members (80) are alternately arranged in the front-to-rear direction.

The first members (70) each include the one tube portion (71) and four tube-side flange portions (72). The tube portion (71) is in the shape of a short cylinder. The tube portion (71) is oriented such that its axis extends in the front-to-rear direction. The tube portion (71) has therein an internal space (I).

The tube-side flange portions (72) are in the shape of a panel. The tube-side flange portions (72) each protrude laterally from the outer circumferential surface of the associated tube portion (71). The tube-side flange portions (72) are each oriented to have flat surfaces generally parallel to the ground. Two of the tube-side flange portions (72) are provided on the left side of each tube portion (71), and other two of the tube-side flange portions (72) are provided on the right side of the tube portion (71). The two right tube-side flange portions (72) are arranged one above the other at predetermined intervals in the circumferential direction. The two left tube-side flange portions (72) are also arranged as with the right tube-side flange portions (72).

The second members (80) each include the one wall surface portion (81) and four wall-surface-side flange portions (82). The wall surface portion (81) is in the shape of a disk. The wall surface portion (81) is disposed to block one end (the rear end) of the tube portion (71) of the associated first member (70). The center of the wall surface portion (81) generally coincides with the axis of the tube portion (71). The wall surface portion (81) has a circular fixed-side hole (83) at its center. The fixed-side hole (83) passes through the wall surface portion (81) in the direction along the panel thickness. A shaft portion (96) of a movable body (M) to be described later is inserted through the fixed-side holes (83).

The wall-surface-side flange portions (82) are each in the shape of a panel. The wall-surface-side flange portions (82) each protrude laterally from the outer circumferential surface of the associated wall surface portion (81). The wall-surface-side flange portions (82) are each oriented to have flat surfaces generally parallel to the ground. Two of the wall-surface-side flange portions (82) are provided on the left side of each wall surface portion (81), and other two of the wall-surface-side flange portions (82) are provided on the right side of the wall surface portion (81). The two right wall-surface-side flange portions (82) are arranged one above the other at predetermined intervals in the circumferential direction. The two left wall-surface-side flange portions (82) are also arranged as with the right wall-surface-side flange portions (82). The wall-surface-side flange portions (82) are provided at the same height as that of the corresponding tube-side flange portions (72).

The tube portions (71) of all of the fixing members (11) have the same diameter. All of the tube portions (71) are oriented such that their axes generally coincide with one another. The wall surface portions (81) of all of the fixing members (11) have the same diameter. All of the wall surface portions (81) are oriented such that their centers generally coincide with the axes of the tube portions (71). A space is formed between the tube portion (71) of each fixing member (11) and the wall surface portion (81) of one of the gas chamber units (A) adjacent to the gas chamber unit (A) including the fixing member (11). In other words, the tube portion (71) of each fixing member (11) and the wall surface portion (81) of one of the gas chamber units (A) adjacent to the gas chamber unit (A) including the fixing member (11) are not in contact with each other.

### Movable Member, Movable Body

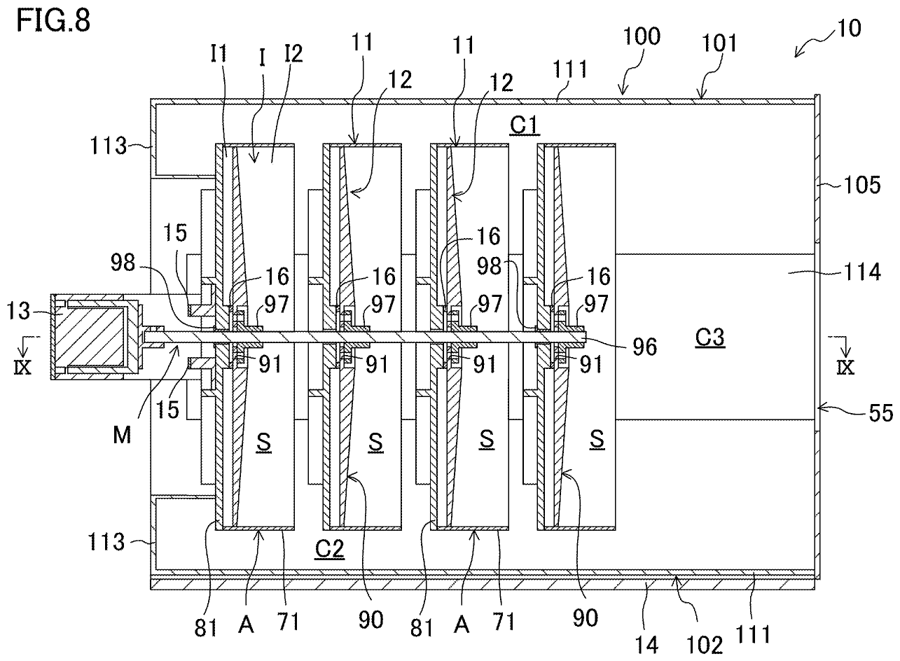

As illustrated in FIG. 8, the movable members (12) each have a movable flat portion (90). The movable flat portion (90) corresponds to a first flat portion of the present disclosure. The movable flat portion (90) is circular and flat. The movable flat portion (90) is disposed in the internal space (I) of the associated tube portion (71). Specifically, the movable flat portion (90) is oriented to cross the internal space (I) of the associated tube portion (71).

Each movable flat portion (90) partitions the internal space (I) of the associated tube portion (71) into a first space (I1) near one end (the rear end) of the tube portion (71) and a second space (I2) near the other end (the front end) of the tube portion (71). The first space (I1) faces the wall surface portion (81) of the associated second member (80). The second space (I2) forms an air chamber (S). In other words, the front surface of the movable flat portion (90) faces the air chamber (S). In each gas chamber unit (A) of this embodiment, a space surrounded by the inner surface of the tube portion (71) and the front surface of the movable flat portion (90) serves as the air chamber (S).

Each movable flat portion (90) has a circular movable-side hole (91) at its center. The movable-side hole (91) passes through the movable flat portion (90) in the thickness direction. The shaft portion (96) of the movable body (M) to be described later is inserted through the movable-side holes (91).

Each movable flat portion (90) is movable through the internal space (I) of the associated tube portion (71) in the forward and rearward directions. A minute clearance is formed between the outer periphery of the movable flat portion (90) of each gas chamber unit (A) and the inner periphery of the associated tube portion (71). This minute clearance is formed such that when the movable flat portion (90) moves forward to push air out of the air chamber (S), the air does not leak from the clearance into the first space (I1).

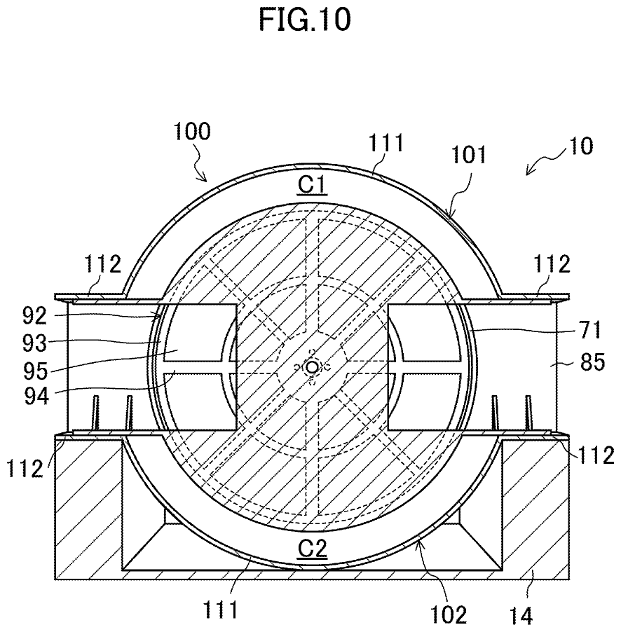

The movable flat portions (90) each include a framework member (92) and a film (95) covering the surface of the framework member (92). The framework member (92) forms the outer shape of the associated movable flat portion (90), and retains the film (95). As illustrated in FIGS. 7 and 10, the framework member (92) includes an outer frame (93) and a support frame (94).

The outer frame (93) is in the shape of a ring, and forms the outer shape of the associated movable flat portion (90). The support frame (94) has a plurality of belt-like portions extending in a radial pattern from the movable-side hole (91) toward the outer frame (93) in the radial direction, and a ring-shaped portion connecting the belt-like portions together. The support frame (94) retains the film (95). The framework member (92) is formed by lightening a thin disk. The film (95) is in the shape of a thin membrane. The film (95) covers the entire surface of the framework member (92).

The movable body (M) of this embodiment includes the movable flat portions (90) of all of the gas chamber units (A), and the shaft portion (96) which is inserted through all of the movable flat portions (90) and to which all of the movable flat portions (90) are fixed. The movable body (M) of this embodiment includes the four movable flat portions (90) and the shaft portion (96). The shaft portion (96) is a rod-shaped member having a circular cross section. The actuator (13) is connected to the rear end of the shaft portion (96). The leading (foremost) one of the movable flat portions (90) is fixed to the front end of the shaft portion (96). The shaft portion (96) is fixed to the movable flat portions (90) via associated tubular flat-portion-fixing members (97). Fixing all of the movable flat portions (90) to the shaft portion (96) via the associated flat-portion-fixing members (97) allows all of the movable members (12) to move together.

The shaft portion (96) is inserted through the fixed-side holes (83) of the wall surface portions (81). The shaft portion (96) is supported by the leading (foremost) and last (rearmost) wall surface portions (81) via associated shaft portion supports (98). The shaft portion (96) is supported by the shaft portion supports (98) so as to be movable in the forward and rearward directions. The shaft portion supports (98) are tubular. Each shaft portion support (98) is disposed in the fixed-side hole (83) of an associated one of the leading and last wall surface portions (81). In other words, no shaft portion supports (98) are disposed in the fixing-side holes (83) of the second and third wall surface portions (81) from the front.

A minute clearance is formed between the shaft portion (96) and the surface defining the fixed-side hole (83) of each of the wall surface portions (81) where the shaft portion support (98) is not disposed. This minute clearance is formed such that when the movable flat portion (90) moves forward to push air out of the air chamber (S), the air does not leak from the clearance into the first space (I1). At the same time, the minute clearance is formed to prevent the outer circumferential surface of the shaft portion (96) from being in contact with the surface defining the fixed-side hole (83) of the wall surface portion (81) when the movable flat portion (90) moves. In this manner, the shaft portion (96) is supported by the wall surface portions (81) of some of the fixing members (11). As a result, the shaft portion (96) moving in the forward and rearward directions slides more smoothly.

### Communication Path, Passage Forming Member

As illustrated in FIGS. 6 and 7, the vortex ring generation device (10) includes the passage forming member (100). The passage forming member (100) is a member for forming the communication path (C). The passage forming member (100) includes an upper cover member (101), a lower cover member (102), a front cover member (105), aright cover member (103), and a left cover member (104).

As illustrated in FIGS. 8 and 10, the upper cover member (101) is disposed above the gas chamber units (A). The lower cover member (102) is disposed below the gas chamber units (A). The upper and lower cover members (101) and (102) are plate-shaped members. The upper cover member (101) includes a cover body (111), cover-side flange portions (112), and a rear blocking portion (113).

The cover body (111) has an arc-shaped cross section. The cover-side flange portions (112) extend laterally from both right and left ends of the cover body (111). The rear blocking portion (113) blocks the rear end of the cover body (111). The cover-side flange portions (112) are each fastened to the associated tube-side flange portions (72) and the associated wall-surface-side flange portions (82). The rear blocking portion (113) is disposed behind the wall surface portion (81) of the rearmost second member (80).

The lower cover member (102) has a configuration similar to that of the upper cover member (101). The cover body (111) of the upper cover member (101) is disposed to cover upper portions of the tube portions (71). A cover body (111) of the lower cover member (102) is disposed to cover lower portions of the tube portions (71). Cover-side flange portions (112) of the lower cover member (102) are fixed to a base (14) provided below the lower cover member (102).

The front cover member (105) is disposed at the front ends of the upper and lower cover members (101) and (102). The front cover member (105) is in the shape of a disk. The front cover member (105) corresponds to a second flat portion of the present disclosure. The front cover member (105) is disposed in front of the foremost gas chamber unit (A). The front cover member (105) has one release port (55) at its center. The release port (55) is a circular opening.

The right and left cover members (103) and (104) are plate-shaped members. The right cover member (103) is disposed on the right side of the front cover member (105). The right cover member (103) is disposed between the upper and lower cover members (101) and (102) in the top-to-bottom direction. The left cover member (104) is disposed on the left side of the front cover member (105). The left cover member (104) is disposed between the upper and lower cover members (101) and (102) in the top-to-bottom direction.

The right cover member (103) includes a side cover body (114) and side flange portions (115). The side cover body (114) has an arc-shaped cross section. The side flange portions (115) extend laterally from both upper and lower ends of the side cover body (114). The side flange portions (115) are each oriented to have flat surfaces generally parallel to the ground. The upper side flange portion (115) is fastened to the cover-side flange portion (112) of the upper cover member (101). The lower side flange portion (115) is fastened to the cover-side flange portion (112) of the lower cover member (102). The left cover member (104) has a configuration similar to that of the right cover member (103).

The communication path (C) is formed by the passage forming member (100). The air chambers (S) of the gas chamber units (A) communicate with one another through the communication path (C). The communication path (C) communicates with the release port (55). In other words, the air chambers (S) of the gas chamber units (A) communicate with the release port (55). The communication path (C) of this embodiment is formed outside the tube portions (71). Specifically, the communication path (C) includes an upper passage (C1), a lower passage (C2), and a central passage (C3).

The upper passage (C1) is formed between the upper cover member (101) and the tube portions (71) of the gas chamber units (A). In other words, the upper passage (C1) is formed above the tube portions (71). The lower passage (C2) is formed between the lower cover member (102) and the tube portions (71) of the gas chamber units (A). In other words, the lower passage (C2) is formed below the tube portions (71).

The central passage (C3) is formed as a space surrounded by the upper cover member (101), the lower cover member (102), the right cover member (103), the left cover member (104), and the front cover member (105). The central passage (C3) is formed in front of the foremost tube portion (71). The central passage (C3) is formed between a pair of the upper and lower passages (C1) and (C2) and the release port (55). The upper and lower passages (C1) and (C2) allow the air chambers (S) of the gas chamber units (A) to communicate with one another. The central passage (C3) allows the upper and lower passages (C1) and (C2) to communicate with the release port (55).

### Cushion Member

As illustrated in FIG. 8, the vortex ring generation device (10) includes a pair of first cushion members (15) and four second cushion members (16). The first and second cushion members (15) and (16) are provided to reduce sound produced by the contact between predetermined members caused by the movement of the movable body (M).

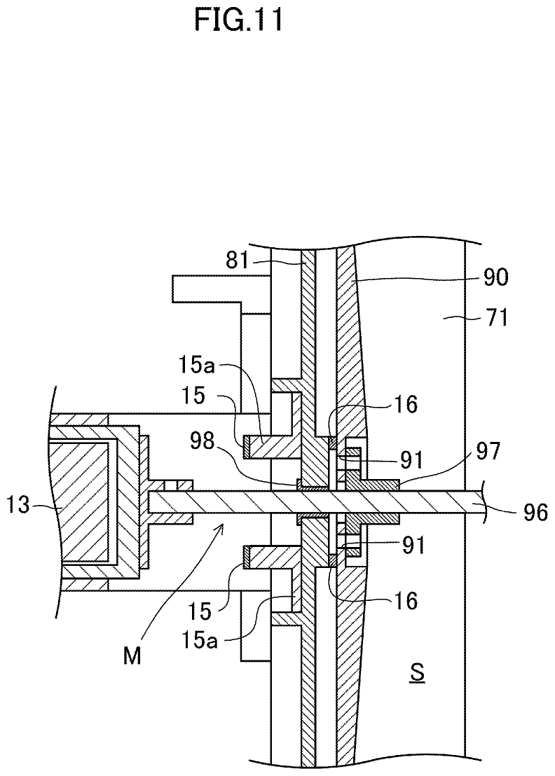

Specifically, as illustrated in FIG. 11, the first cushion member (15) is fixed to a (rear) surface of the rearmost wall surface portion (81) near one end thereof via a cushion fixing member (15a). The first cushion members (15) are vertically disposed around the fixed-side hole (83) of the wall surface portion (81). The first cushion member (15) is in the shape of a rectangular thin plate. The cushion fixing member (15a) is oriented to protrude rearward (toward the actuator (13)) from the (rear) surface of the rearmost wall surface portion (81) near the one end thereof. The first cushion member (15) is fixed to a protruding end portion of the cushion fixing member (15a). The first cushion member (15) provided as described above can reduce sound produced by the contact between the actuator (13) and the wall surface portion (81) closest to the actuator (13) caused by the movement of the movable body (M) from the reference position to the pushed position.

The second cushion members (16) are each fixed to the center of a (front) surface of the associated wall surface portion (81) near the other end thereof. Each second cushion member (16) is generally in the shape of a ring. The second cushion member (16) is disposed all around the fixed-side hole (83) of the associated wall surface portion (81). The second cushion member (16) provided as described above can reduce sound produced by the contact between the wall surface portion (81) and the movable flat portion (90) of the associated gas chamber unit (A) caused by the movement of the movable body (M) from the pushed position to the reference position.

### Suction Passage

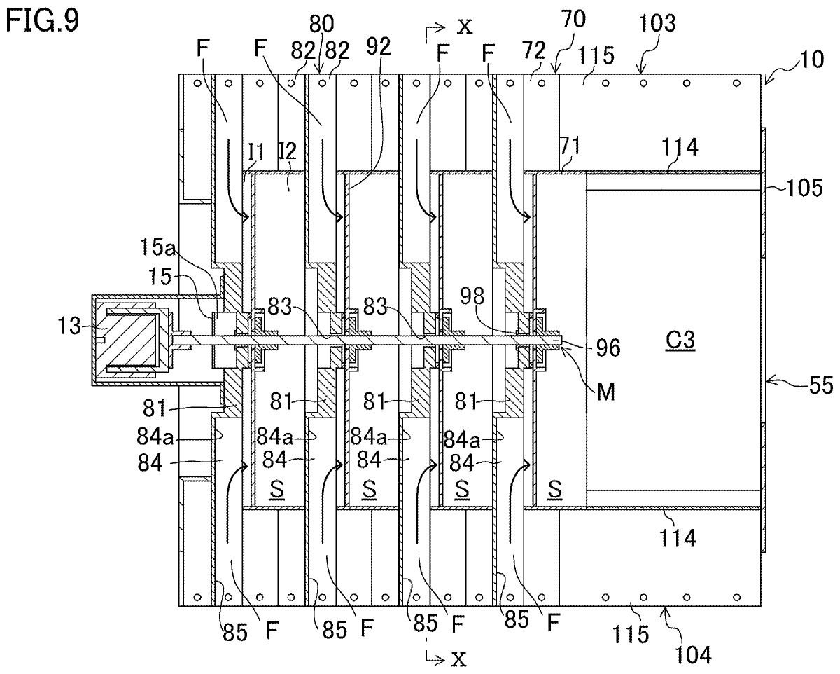

As illustrated in FIG. 9, the vortex ring generation device (10) includes suction passages (F). Each suction passage (F) is a passage through which the first space (I1) of the associated tube portion (71) communicates with the outside of the communication path (C). The suction passage (F) is formed in the internal space of an associated one of suction recess portions (84). In other words, each suction recess portion (84) allows the associated first space (I1) to communicate with the outside of the communication path (C). The suction recess portion (84) corresponds to a recess portion of the present disclosure.

The suction recess portions (84) are formed on the wall surface portion (81) of each of the gas chamber units (A). The suction recess portions (84) are respectively formed on right and left portions of each wall surface portion (81). The right and left suction recess portions (84) are formed on an intermediate portion of the associated wall surface portion (81) in the top-to-bottom direction. Each suction recess portion (84) extends rearward. A bottom surface portion (84a) of the suction recess portion (84) has a rectangular shape with long sides running in the top-to-bottom direction and short sides running in the right-to-left direction.

Each second member (80) has two extension sections (85). Each extension section (85) extends laterally from an end portion of the bottom surface portion (84a) of the associated suction recess portion (84). Each of the right extension sections (85) connects together the upper and lower wall-surface-side flange portions (82) on the right side of the associated second member (80). Each of the left extension sections (85) is provided as with each of the right extension sections (85). The extension sections (85) each guide air outside the communication path (C) to the internal space of the associated suction recess portion (84).

The vortex ring generation device (10) having the suction passages (F) as described above causes air in the associated air chambers (S) to be pushed out in accordance with the motion of the actuator (13), and simultaneously causes air outside the communication path (C) to be sucked into the associated first spaces (I1). This can substantially keep the pressure of the first spaces (I1) from decreasing. As a result, the movable members (12) can be smoothly moved.

### Operation

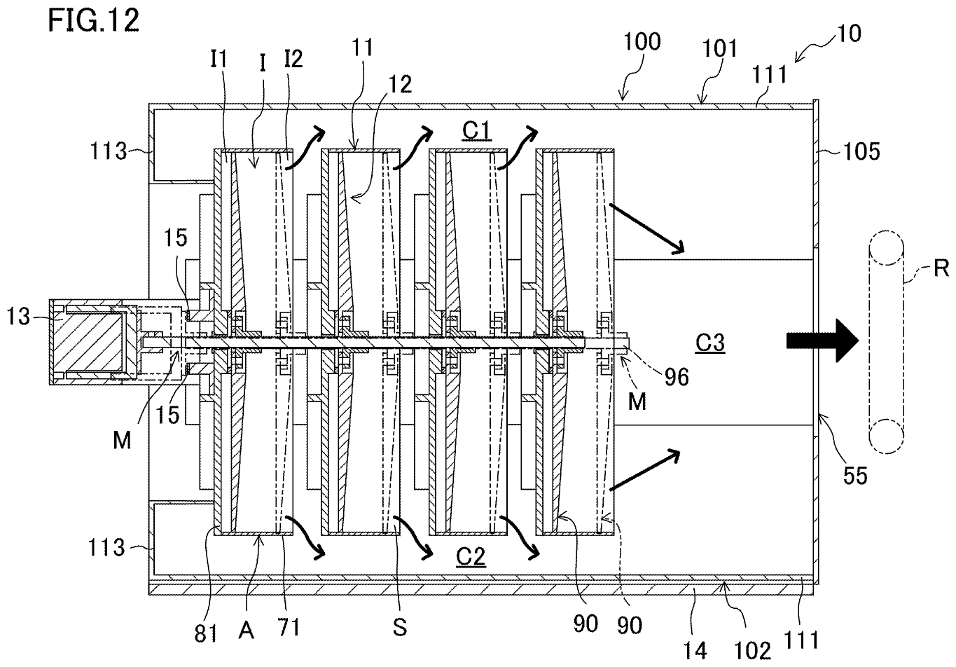

Basic operation of the vortex ring generation device (10) according to this embodiment will be described with reference to FIG. 12. In FIG. 12, a state in which the movable body (M) is located at the reference position is indicated by the solid lines, and a state in which the movable body (M) is located at the pushed position is indicated by the dashed and double-dotted lines.

The vortex ring generation device (10) in an operating state causes the actuator (13) to reciprocate the movable body (M) forward and rearward. Specifically, driving of the actuator (13) causes the shaft portion (96) connected to the actuator (13) to reciprocate in the forward and rearward directions. The reciprocation of the shaft portion (96) causes all of the movable flat portions (90) fixed to the shaft portion (96) to reciprocate together with the shaft portion (96). The movable body (M) reciprocates between the reference position and the pushed position.

If the driving of the actuator (13) causes the movable flat portions (90) of the gas chamber units (A) to move forward (as indicated by the dashed and double-dotted lines in FIG. 12), the capacity of the associated air chambers (S) decreases. The decrease in the capacity of each air chamber (S) causes air with a volume equal to the capacity decrement to be pushed out of the air chamber (S). The air pushed out of the air chambers (S) flows into the central passage (C3) through the upper and lower passages (C1) and (C2) formed outside the tube portions (71). The air that has flowed into the central passage (C3) flows toward the release port (55), and the air in the form of a vortex ring is released from the release port (55).

As indicated by the solid arrows in FIG. 9, while the driving of the actuator (13) causes the movable flat portions (90) of the gas chamber units (A) to move forward, and the air in the air chambers (S) is thus pushed forward, the air outside the communication path (C) is sucked into the suction passages (F). More specifically, when the movable flat portions (90) of the gas chamber units (A) move forward, air outside the vortex ring generation device (10) flows into the vortex ring generation device (10) from the right and left extension sections (85) of each second member (80), and is sucked into the suction recess portions (84) corresponding to the extension sections (85). The air sucked into the suction passages (F) flows into the first spaces (I1) of the tube portions (71). This can substantially keep the pushing of air out of the air chambers (S) from causing the decrease in the pressure of the associated first spaces (I1). Thus, the movable flat portions (90) can be smoothly moved.

### Feature (1) of Fourth Embodiment

In the vortex ring generation device (10) of this embodiment, the movable body (M) includes the movable flat portions (90) of all of the gas chamber units (A), and the shaft portion (96) which is inserted through all of the movable flat portions (90) and to which all of the movable flat portions (90) are fixed. The actuator (13) is connected to an end portion of the shaft portion (96).

This simplifies the structure of the movable body (M). Thus, the amount of movement of the movable members (12) can be freely determined. As a result, the amount of air pushed out by the movable members (12) can be increased without increasing the number of the movable members (12) or without increasing the area of each movable member (12). This can substantially keep the size of the vortex ring generation device (10) from increasing.

Further, unlike the vortex ring generation device (10) of the first embodiment, the vortex ring generation device (10) of this embodiment includes no elastic supports (22). Thus, the distance over which the movable members (12) are movable is not limited. This allows the amount of movement of the movable members (12) to be larger than the structure in the first embodiment.

In addition, when the movable members (12) move, the elastic supports (22) of the vortex ring generation device (10) of the first embodiment have high deformation resistance. In contrast, in the vortex ring generation device (10) of this embodiment, the frictional force of the shaft portion (96) is relatively small. Thus, the vortex ring generation device (10) of this embodiment can move the movable body (M) under a smaller driving force than the vortex ring generation device of the first embodiment. As a result, the load on the actuator (13) is reduced.

In addition, the elastic supports (22) of the vortex ring generation device (10) of the first embodiment support the associated movable members (12). This may cause the elastic supports (22) to be bent depending on the orientation of the vortex ring generation device (10) installed. The elastic supports (22) bent cause contact between a coil and a magnet forming the actuator (13). This increases the driving resistance, and causes contact noise. To address this problem, in the vortex ring generation device (10) of this embodiment, all of the movable flat portions (90) are fixed by the shaft portion (96). Thus, irrespective of the orientation of the vortex ring generation device (10) installed, the coil and the magnet of the actuator (13) are less likely to be in contact with each other. Thus, the orientation of the vortex ring generation device (10) installed can be freely determined.

### Feature (2) of Fourth Embodiment

In the vortex ring generation device (10) of this embodiment, the wall surface portions (81) each have the suction recess portion (84) that allows the first space (I1) of the associated tube portion (71) to communicate with the outside of the communication path (C). This causes the movable members (12) to push air out of the associated air chambers (S), and simultaneously causes air outside the communication path (C) to be sucked into the first spaces (I1). This can substantially keep the movement of the movable members (12) from lowering the pressure of the first spaces (I1). As a result, the movable members (12) can be smoothly moved.

### Feature (3) of Fourth Embodiment

In the vortex ring generation device (10) of this embodiment, the communication path (C) is formed outside the tube portions (71), and communicates with the release port (55). This allows the air in the air chamber (S) of each gas chamber unit (A) to be released through the communication path (C) formed outside the tube portions (71) and the release port (55) to the outside of the vortex ring generation device (10). Since the communication path (C) is formed outside the tube portions (71) as described above, the communication path (C) with a simple structure can be formed.

### Feature (4) of Fourth Embodiment

Each movable flat portion (90) of the vortex ring generation device (10) of this embodiment includes the framework member (92) and the film (95) covering the surface of the framework member (92). This allows the movable flat portion (90) to be lighter than if the movable flat portion (90) is configured as a flat plate.

### Feature (5) of Fourth Embodiment

The movable flat portions (90) of the vortex ring generation device (10) of this embodiment are circular. This can substantially keep even the movable flat portions (90) rotating in accordance with the driving of the actuator (13) from interfering with parts surrounding the movable flat portions (90).

### Feature (6) of Fourth Embodiment

The shaft portion (96) of the vortex ring generation device (10) of this embodiment is supported by the leading (foremost) and last (rearmost) wall surface portions (81) via the associated shaft portion supports (98). According to this configuration, reducing the number of the portions supporting the shaft portion (96) can improve the sliding of the shaft portion (96).

### Variations of Fourth Embodiment

### First Variation

The movable flat portions (90) of the vortex ring generation device (10) of this embodiment may be each formed in the shape of a flat panel.

### Second Variation

In the vortex ring generation device (10) of this embodiment, the gas chamber units (A) may have different cross-sectional areas. For example, the cross-sectional area of the gas chamber units (A) may decrease in the forward direction. More specifically, the cross-sectional area of the fixing members (11) and the area of the movable members (12) may decrease in the forward direction. In this case, the upper and lower passages (C1) and (C2) each have its radial length increased in the forward direction. According to this configuration, the air resistance of the communication path (C) decreases in the forward direction. This allows the air to flow more easily through the communication path (C).

### Third Variation

In the vortex ring generation device (10) of this embodiment, the passage forming member (100) may be configured such that the radial lengths of the upper and lower passages (C1) and (C2) increase in the forward direction. According to this configuration, the air resistance of the communication path (C) decreases in the forward direction. This allows the air to flow more easily through the communication path (C).

### Fourth Variation

In the vortex ring generation device (10) of this embodiment, the front cover member (105) of the passage forming member (100) may have a plurality of release ports (55). According to this configuration, a plurality of vortex rings (R) can be simultaneously released from the vortex ring generation device (10) in accordance with the driving of the actuator (13).

### Fifth Variation

In the vortex ring generation device (10) of this embodiment, the gas chamber units (A) may have a cross section with any shape except a circle. For example, the cross section of each gas chamber unit (A) may be in the shape of a polygon, such as a quadrangle. More specifically, the longitudinal sections of the fixing members (11) and the movable members (12) are each formed in the shape of a polygon. According to this configuration, the movable flat portions (90) can each have a larger area than if the gas chamber units (A) each have a circular cross section. This increases the amount of the air pushed out of the air chambers (S).

### Sixth Variation

In the vortex ring generation device (10) of this embodiment, a spring or a magnet may be disposed instead of the first cushion member (15) or each of the second cushion members (16). According to this configuration, using the repulsive force of the spring or the magnet can reduce the sound resulting from the contact between predetermined members caused by the movement of the movable body (M).

### OTHER EMBODIMENTS

The above embodiments may also be configured as follows.

In the vortex ring generation device (10) of each of the above embodiments, vortex rings (R) may each contain a release component. Examples of the release component include a fragrance component, a vapor, and a substance having a predetermined effect.

While the embodiments and variations thereof have been described above, it will be understood that various changes in form and details may be made without departing from the spirit and scope of the claims. The embodiments, the variations, and the other embodiments may be combined and replaced with each other without deteriorating intended functions of the present disclosure.

The ordinal numbers such as “first,” “second,” and “third” described above are used to distinguish the terms to which these expressions are given, and do not limit the number and order of the terms.

As described above, the present disclosure is useful for a vortex ring generation device.

1. A vortex ring generation device for releasing an airflow in a form of a vortex ring from a release port, the vortex ring generation device comprising:
a plurality of gas chamber units, each gas chamber unit having an air chamber that communicates with the release port, and each gas chamber units including
a fixing member forming the air chamber, and
a movable member moving to push air out of the air chamber,
the movable members of all of the gas chamber units being coupled together to form one movable body;
an actuator connected to an end portion of the movable body and configured to drive the movable body; and
a communication path allowing the air chambers of the plurality of gas chamber units to communicate with each other.

2. The vortex ring generation device of claim 1, wherein
the plurality of gas chamber units are arranged along a line.

3. The vortex ring generation device of claim 1, wherein
the actuator reciprocates the movable body, and
the plurality of gas chamber units are arranged along a line along a direction of movement of the movable body.

4. The vortex ring generation device of claim 1, wherein
the movable member and the fixing member form the air chamber,
the plurality of gas chamber units include one or more first gas chamber units and one second gas chamber unit,
the release port is formed in the fixing member of the second gas chamber unit,
the movable body is formed by the movable members of all of the gas chamber units coupled together, and
the communication path allows the air chamber of each of the one or more first gas chamber units to communicate with the air chamber of the second gas chamber unit.

5. The vortex ring generation device of claim 4, wherein
one of the plurality of movable members that form the movable body is a direct-acting movable member directly coupled to the actuator, and
another one of the movable members that form the movable body, other than the direct-acting movable member, is a driven movable member driven by the actuator via the direct-acting movable member.

6. The vortex ring generation device of claim 5, wherein
the movable member of each first gas chamber unit includes a flat panel portion facing an associated one of the air chambers.

7. The vortex ring generation device of claim 6, wherein
the flat panel portions of the movable members have a circular shape, and are coaxial with each other.

8. The vortex ring generation device of claim 7, wherein
the actuator reciprocates the movable body along a direction of arrangement of the plurality of movable members that form the movable body.

9. The vortex ring generation device of claim 6, wherein
the communication path passes through the flat panel portion of at least one of the movable members.

10. The vortex ring generation device of claim 6, wherein
one of the plurality of movable members that form the movable body is a direct-acting movable member directly coupled to the actuator,
another one of the movable members that form the movable body, other than the direct-acting movable member, is a driven movable member driven by the actuator via the direct-acting movable member, and
the driven movable member has a through hole forming the communication path.

11. The vortex ring generation device of claim 10, wherein
the through hole is formed in a center of the flat panel portion of the driven movable member.

12. The vortex ring generation device of claim 11, wherein
the through hole is circular.

13. The vortex ring generation device of claim 4, wherein
at least one of the movable members includes
a flat panel portion facing the air chamber; and
a tubular portion passing through the flat panel portion to form the communication path.

14. The vortex ring generation device of claim 5, wherein
the direct-acting movable member and the driven movable member each include a flat panel portion facing the air chamber, and
of the direct-acting movable member and the driven movable member, only the driven movable member further includes a tubular portion passing through the flat panel portion to form the communication path.

15. The vortex ring generation device of claim 14, wherein
the tubular portion of the driven movable member allows the air chamber of one of the first gas chamber units including the driven movable member to communicate with the air chamber of an other one of the first gas chamber units adjacent to the one of the first gas chamber units including the driven movable member.

16. The vortex ring generation device of claim 15, wherein
the fixing member of the other one of the gas chamber units adjacent to the one of the first gas chamber units including the driven movable member has a communication opening that allows the air chamber of the other one of the gas chamber units to communicate with the tubular portion of the driven movable member.

17. The vortex ring generation device of claim 16, further comprising:
a sealing portion configured to seal a gap between
the tubular portion of the driven movable member and
the fixing member of the other one of first the gas chamber units adjacent to the one of the first gas chamber units including the driven movable member.

18. The vortex ring generation device of claim 14, wherein
the driven movable member includes a coupling portion coupling the tubular portion of the driven movable member to
the direct-acting movable member or
the driven movable member of the other one of the first gas chamber units adjacent to the one of the first gas chamber units including the driven movable member.

19. The vortex ring generation device of claim 1, wherein
the movable member of each first gas chamber unit includes a first flat portion facing the air chamber,
the movable body includes
the first flat portions of all of the first gas chamber units, and
a shaft portion, which is inserted through all of the first flat portions and to which all of the first flat portions are fixed, and
the actuator is connected to an end portion of the shaft portion.

20. The vortex ring generation device of claim 19 further comprising:
a passage forming member forming the communication path,
the fixing member of each first gas chamber unit including a tube portion and a wall surface portion blocking one end of the tube portion,
the first flat portion of each movable member
crossing an internal space of the tube portion, and
partitioning the internal space into a first space near the one end of the tube portion and a second space near another end of the tube portion,
the first space facing the wall surface portion,
the second space forming the air chamber, and
the wall surface portion having a recess portion that allows the first space to communicate with outside of the communication path.

21. The vortex ring generation device of claim 20, wherein
the passage forming member has the release port, and
the communication path is formed outside the tube portions, and the communication path communicates with the release port.

22. The vortex ring generation device of claim 21, wherein
the passage forming member includes a second flat portion having the release port, and the release port including a plurality of release ports.

23. The vortex ring generation device of claim 19, wherein
the first flat portion of each movable member includes a framework member and a film covering a surface of the framework member.
